(19) United States
(12) Patent Application Publication
(10) Pub. No.: US 2006/0121423 A1
(43) Pub. Date: Jun. 8, 2006

(54) Vocational training apparatus that provides audio instructions

(76) Inventor: Jay W. Hutchison, Racine, WI (US)

Correspondence Address: S.C. JOHNSON COMMERCIAL MARKETS INC, 8310 16TH STREET, M/S 510, PO BOX 902, STURTEVANT, WI, 53177-0902, US

(21) Appl. No.: 11/005,661

(22) Filed: Dec. 7, 2004

(51) Int. Cl. G09B 19/00

(52) U.S. Cl. 434/219

(57) ABSTRACT

An apparatus provides audio instructions to a worker regarding job tasks to be performed and is adapted to be position at a location where the worker performs the tasks. A chart has a plurality of symbols related to the different job tasks and a user input assembly is associated with the symbols. The user input assembly is activated by the worker selecting one of the plurality of symbols which thereby produces an electrical signal indicating a selected symbol. A storage device contains a plurality of audio instructional messages corresponding to the plurality of symbols. An audio playback circuit is connected to the user input assembly and the storage device, and responds to the electrical signal by playing the audio instructional message that is associated with the selected symbol.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to educational equipment for vocational training, and in particular to an audio/visual apparatus which is located at a work station to provide instruction on a plurality of job tasks that a worker is to perform at that location.

2. Description of the Related Art

Many industries have jobs which require very little skill and thus, are filled by persons having minimal education, learning disabilities, or immigrants who may not be fluent in the language of the country where the work is being performed. Such employees may not have the fundamental ability to perform even relatively unskilled tasks, such as janitorial services and motel housekeeping, without training. However, these workers may have very poor retention of the instruction that is provided to them. Consequently, as more illiterate, immigrant and/or mentally challenged individuals are hired, businesses must increasingly address the need to adequately train these workers to be efficient and productive members of the organization.

The employer's role is complicated further because of the relatively high turn-over rates associated with many of these unskilled jobs. This requires that training programs for new employees be given almost continuously.

Even many of what are considered relatively unskilled jobs require a certain knowledge of how to properly perform the associated tasks in order that the job be properly performed. In a restroom for example, different cleansing solutions and techniques are utilized for the different surfaces and rest room fixtures being cleaned, thus an employee has to be instructed on which solution to use for various tasks. For example, a disinfecting solution must remain on the surfaces being cleaned for a specified amount of time in order to kill bacteria. That period of time varies depending upon the particular disinfectant utilized. In another situation, a proper amount of concentrated detergent must be mixed with a certain quantity of water in order to produce a cleansing solution. Inadequate cleaning occurs if too little detergent is used and using too much detergent is not only wasteful, but may damage the surfaces being cleaned. As a consequence, employees must be instructed as to the proper cleaning techniques and in some cases, frequently reminded of them.

Other jobs such as those in a fast food establishment also require well trained employees to ensure that the food is properly prepared and safe practices are followed.

Thus, it is desirable to provide instructional aides near the location at which the work tasks are being performed so that a worker may refer to the aides as necessary to perform his or her job.

### SUMMARY OF THE INVENTION

A vocational instruction apparatus for educating a worker comprises a plurality of symbols related to a job that the worker is to perform. For example, the symbols may depict different job tasks or different implements that the worker uses. A user input assembly is associated with the plurality of symbols and enables the worker to select one of the plurality of symbols which causes the user input assembly to produce an electrical signal indicating a selected symbol.

A storage device is provided to contain a plurality of audio instructional messages with each one providing information associated with a different symbol. For example, the audio instructional messages may provide information regarding how to perform a job task, proper use of a work implement, and workplace and equipment safety. These messages may describe how to perform a task or use a implement, including safety instructions for the implement. An audio playback circuit is connected to the user input assembly and the storage device. The audio playback circuit responds to the electrical signal by presenting the worker with the particular audio instructional messages that is associated with the selected symbol.

In a preferred embodiment of the vocational instruction apparatus, the plurality of symbols are printed on a removable chart and the storage device also is removable, thereby allowing the apparatus to be easily reprogrammed for other tasks.

One aspect of the present invention is to provide a mechanism to read an identifier of the worker from an employee identification card and store the identifier in a memory of the vocational instruction apparatus. A timer also can be provided to measure the amount of time the worker takes to perform a job task and store an indication of that amount of time in the memory. The stored information is useful in evaluating the worker's performance.

### BRIEF DESCRIPTION OF THE DRAWINGS

FIG. 1 is a an isometric view of a vocational training apparatus according to the present invention;

FIG. 2 is an isometric view of the vocational training apparatus with the front cover removed;

FIG. 3 is a block schematic diagram of the electronic circuitry of the vocational training apparatus;

FIG. 4 is a flowchart of a software program executed to perform the vocational training; and

FIG. 5 is a flowchart of an alternative software program.

### DETAILED DESCRIPTION OF THE INVENTION

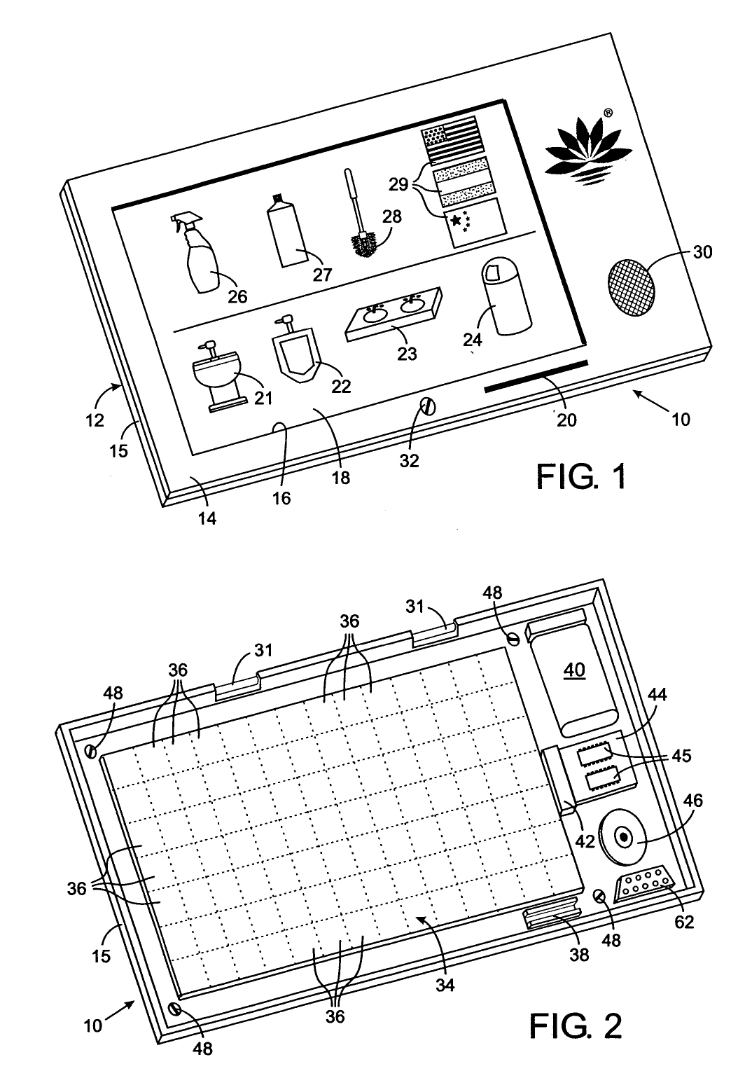

With initial reference to FIG. 1, a vocational training apparatus 10 is provided for placement at a location where work will be performed. For example, the apparatus has a housing 12 which can be secured to a wall or the back of a door in a restroom in order to provide instruction regarding the various cleaning tasks to be performed there. Although the present invention is being described in the context of cleaning a restroom, it should be appreciated that it can utilized to instruct on tasks associated with a variety of other jobs. For example, it can be used to provide instruction on the proper preparation of food at a fast food establishment, how to clean floors in a commercial building, or perform a wide variety of skilled and unskilled jobs.

The housing 12 comprises a front panel 14 and a rear panel 15. The front panel 14 has a rectangular opening 16, thereby forming a picture frame for a chart 18 that is held sandwiched between the front and rear panels. As will be described in greater detail, the chart 18 is a sheet of material on which is printed a plurality of symbols 21-28, related to the job tasks that a worker is to perform at the location at which the apparatus 10 is positioned. For the exemplary apparatus 10 that is to be used in a restroom, the symbols include task symbols 21, 22, 23 and 24 representing various items needing to be cleaned and a plurality of implement symbols 26, 27 and 28 depicting implements, such as tools and cleaning solutions, that are used in performing those job tasks. Several flag symbols 29 are provided to indicate different languages in which the instructions can be given.

The front panel 14 also has a slot 20 through which the worker is able to insert his or her employee identification badge to activate the apparatus 10. An opening 30 allows the emission of sound produced by an internal speaker. The front panel 14 is attached by a releasable hinge mechanism 31 along the upper edge (See FIG. 2) with a fastener such as a machine screw 32 holding the bottom edge against the rear panel 15.

FIG. 2 illustrates the vocational instruction apparatus 10 with the front panel 14 removed, showing the internal components mounted the rear panel 15. The printed chart 18 which is normally held between the two panels 14 and 15 also has been removed. A touch screen 34 is mounted on the rear panel 15 in registration with the opening 16 in the front panel and over which the printed chart 18 is placed. The touch screen 34 can comprise any of several commercially available devices which form a plurality of touch sensitive areas 36 arranged in a two dimensional matrix as denoted by the dashed lines. Any of the well known touch screen technologies may be used in the present apparatus, including employing a separate membrane electrical switch under each touch sensitive area 36. When one of these touch sensitive areas 36 is activated by being pressed by a user, the touch screen 34 produces an electrical signal indicating which area has been activated. As a result, when a worker pushes one of the symbols 21-28 on the chart 18 in FIG. 1, the touch screen 34 produces an electrical signal indicating the area under that touched symbol. Thus the signal can be used to determine which symbol was selected by the worker.

An card sensor 38 is located on the rear panel 15 underneath the front panel slot 20 and produces an electrical signal upon insertion of an employee identification card through that opening. This card sensor 38 may be simply a switch which is activated upon the insertion of the identification card. Alternatively, the card sensor 38 may comprise a reader for a magnetic strip or a barcode on the employee identification card. Readers of this type are commonly used by employees to unlock doors or to “clock” in and out of work in a time and attendance system. Such readers thus identify the particular employee who is activating the apparatus 10.

The rear panel 15 also contains a battery 40 which supplies power to the vocational instruction apparatus. Alternatively, a solar cell panel can provide power to the apparatus from light at the work location. A connector 42 receives a memory card 44 with electronic storage devices 45 in the form of integrated circuits that store a plurality of digitized audio instructional messages related to the job tasks and implements for the work location at which the apparatus is positioned. The memory card 44 also stores data that relates selected touch sensitive areas 36 on the touch screen 34 to the different instructional messages. For example the touch sensitive areas 36 underneath the toilet symbol 21 are associated with the instructional message for cleaning a toilet. This pressing a chart symbols 21-28 activates the message about that job task or implement. The memory card 44 is removable so that it can be replaced along with the chart 18 as the job tasks or the directions for using the implements for the work location change. Other types of electronic data storage devices, such as those that retain the data on magnetic or optical medium, may be substituted for the memory card. A speaker 46 is provided through which the audio messages are played to the worker.

A plurality of fasteners 48, such as screws, extend through apertures in the rear panel 15 to secure the apparatus 10 at the work location. For example, the apparatus 10 can be fastened to the inside surface of a door or wall in the restroom. Alternatively, other types of fastening mechanisms can be provided to attach the apparatus 10 to an appropriate position adjacent the work location, such as a cooking station in a fast food restaurant, a cart containing equipment to clean spills in a workplace, or a machine used to clean or wax floors. It should be appreciated that an all inclusive list of the various work locations and tasks with which the present apparatus 10 can be used is virtually impossible to provide and would unnecessarily increase the length of the present description. Therefore, applicants should not be restricted in the particular work locations or tasks with which the present instructional apparatus may be utilized.

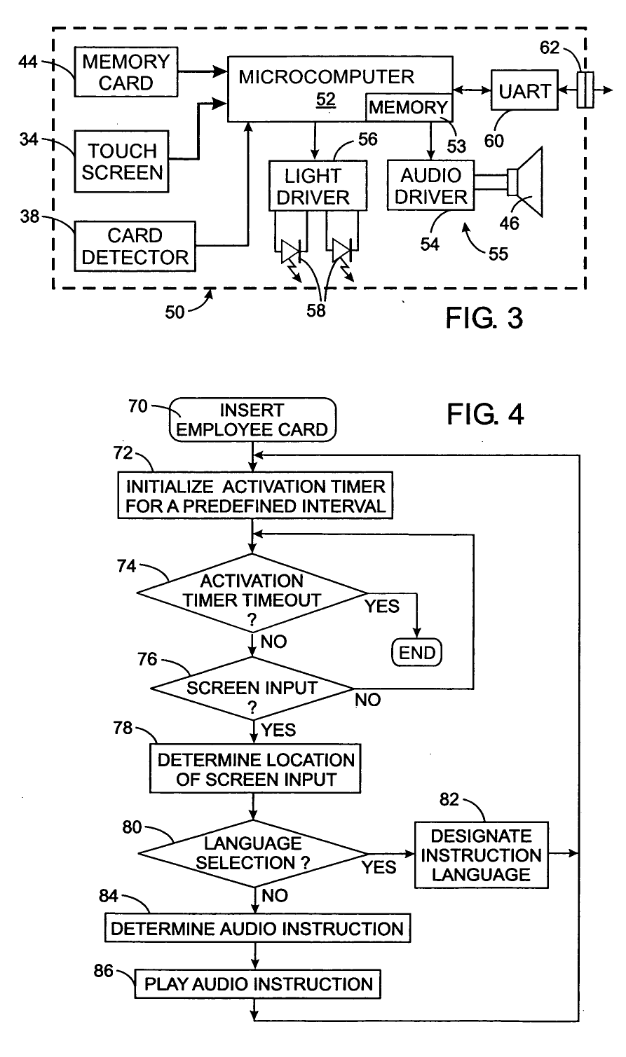

The various components mounted on the rear panel 15 are part of an electronic circuit which governs the operation of the apparatus 10. With reference to FIG. 3, that electronic circuit 50 is built around a microcomputer 52 that includes a microprocessor and internal memory 53 which stores a software program that the microprocessor executes to perform the educational functions. Data generated during the execution of that program also is stored in the microcomputer memory 53. The memory card 44 is addressable by the microcomputer 52 to obtain the operational data and digitized audio messages stored therein. As noted previously, the memory card 44 contains data that relates selected touch sensitive areas 36 on the touch screen 34 to specific instructional messages. The touch screen 34 is electrically connected to inputs of the microcomputer 52 as is the card sensor 38. The microcomputer has outputs connected to an audio driver 54 or speech synthesizer which produces an audio signal that is applied to the speaker 46. The microcomputer 52, the audio driver 54 and the speaker 46 form an audio playback circuit 55 for playing the instructional messages to a worker. Additional outputs of the microcomputer 52 operate a light driver 56 which independently activates one or more light emitters, such as LED's 58. The light emitters indicate the operating status of the apparatus 10 and also may be associated with the chart symbols 21-28 to provide an optical feedback to the worker regarding which symbol has been selected.

Although operation of the apparatus 10 can be reconfigured by changing the memory card 44, configuration data and instructional messages also can be downloaded through a connector 62 on the rear panel 15 and a communication interface 60, such as universal asynchronous receiver/transmitter (UART). Information regarding utilization of the apparatus by employees and their task performances can be extracted from the apparatus 10 via the communication interface 60. The communication interface 60 may be connected directly to a communication network at the workplace so data can be exchanged with other computers. In other situations, a portable computer can be brought to the work location and connected to the communication connector 62 for data exchange. Alternatively other methods using radio frequency, telephonic, or optical communication devices, can be employed to exchange information between the apparatus 10 and other equipment.

With reference to FIGS. 1 and 4, when a worker enters the restroom to perform the cleaning tasks, he or she inserts an employee identification card into slot 20 on the front of the vocational instruction apparatus 10. That action is sensed by the card sensor 38 which in this version of the apparatus is a switch which provides a signal to the microcomputer 52 which responds at step 70 by commencing execution of the instructional program. Other mechanisms can be provided to activate the vocational instruction apparatus. For example, a start symbol can be printed on the chart 18, whereby pressing that symbol produces a signal from the touch screen 34 that initiates program execution. This alternative element for commencing the job instruction has application at work locations to which the public does not have access. When vocational instruction apparatus 10 is positioned at a public location, requiring insertion an employee identification card inhibits members of the public, such as customers using the restroom, from readily activating the apparatus 10.

The software program initializes an activation timer for a predefined interval specified by data read from the memory card 44 at step 72. The activation timer is implemented by the software and provides a mechanism which automatically deactivates the instructional apparatus 10 if too much time passes without the worker again pressing the touch screen 34. The predefined interval should be sufficiently long to allow the task requiring the greatest amount of time to be performed without the timer expiring. A grace period may be added to accommodate slow workers and interruptions. This not only provides a mechanism which deactivates the apparatus at the completion of the tasks at the work location, but also prevents the instructional apparatus from being left on indefinitely should less than all of the tasks be performed.

The execution of the software controlling the apparatus advances to step 74 where the activation timer is inspected to determine whether it has timed-out, i.e. the predefined interval elapsed without activation of the touch screen 34. If the activation timer has expired, the program terminates. Otherwise, the program execution advances to step 76 where the inputs from the touch screen 34 are examined by the microcomputer 52 to determine whether any touch sensitive area 36 has been activated by the worker. If that is not the case, the program execution loops back to step 74. The loop through steps 74 and 76 continues until either the activation timer has expires or the touch screen 34 is activated.

Upon receiving a touch screen signal, the program execution advances to step 78 at which microcomputer 52 uses that signal to determine the location of the screen activation. Then, at step 80, the location of the screen activation is examined to conclude whether it resulted from the worker touching one of the flag symbols 29. For example, the flags may correspond to the United States for English, Mexico for Spanish, and China for Chinese. However, the particular flags and thus the languages in which the instructions are provided can be varied based on the nationality of workers at a particular business that uses the apparatus. If that is a flag was selected by the worker, the particular flag is determined and used to step 82 to designate the language in which to deliver instructions to the worker. Specifically, the microcomputer sets a variable to a value indicating the selected language. That variable is set to a default value each time the instructional program commences thereby designating a default language. After the language variable has been set at step 82, the program execution loops back to the step 72 to reset the activation timer and await another touching of the screen 34.

When the worker touches one of the task or implement symbols 21-28, the program advances to step 84 where a determination made which audio instruction is associated with the touch sensitive area 36 that was activated. For example, the touch sensitive areas 36 underneath one of the task symbols 21-24 on the chart 18 correspond to different first audio instructional messages related to various job tasks at the present work location. For example, touching task symbol 21 depicting a toilet causes an audio instructional message about cleaning a toilet to be played, whereas symbol 22 provides instructions regarding cleaning a urinal. Task symbol 23 denotes cleaning sinks and the associated counter surface, while symbol 24 represents emptying a trash receptacle. The activated touch sensitive area 36 may correspond an implement, in this case for cleaning and disinfecting fixtures of a restroom as depicted by the implement symbols 26-28 for cleaning solution containers and a brush or other tool. The audio instruction related to the job task or implement that was touched is selected at step 84 based on the location at which the touch screen activation occurred. Then at step 86, that selection is used to access the respective memory locations within the memory card 44 that contain the digitized audio instructional message for the selected job task or implement. In the case of an implement, instruction is provided on its proper usage and safety precautions, as well as remedies for accidental misusage, e.g. eye contact or ingestion of a cleaning solution. The microcomputer 52 applies the retrieved audio instructional message to the audio driver 54 which plays the message through the speaker 46.

When the instruction message has completed playing, the program returns to step 72 to restart the activation timer, and then await further activation of the touch screen 34. Specifically, when the worker completes one of the job tasks depicted on the chart 18, he or she activates another task symbol, until all of the tasks at this work location have been completed. At that time, the worker may simply leave the restroom, thereby allowing the activation timer to eventually time-out, which is detected at step 74, causing operation of the apparatus 10 to terminate. Alternatively, the software can be configured so that upon completion of all the tasks, the worker reinserts an employee identification card into slot 20 which subsequent insertion is sensed by the card sensor 38 thereby terminating the instructional program.

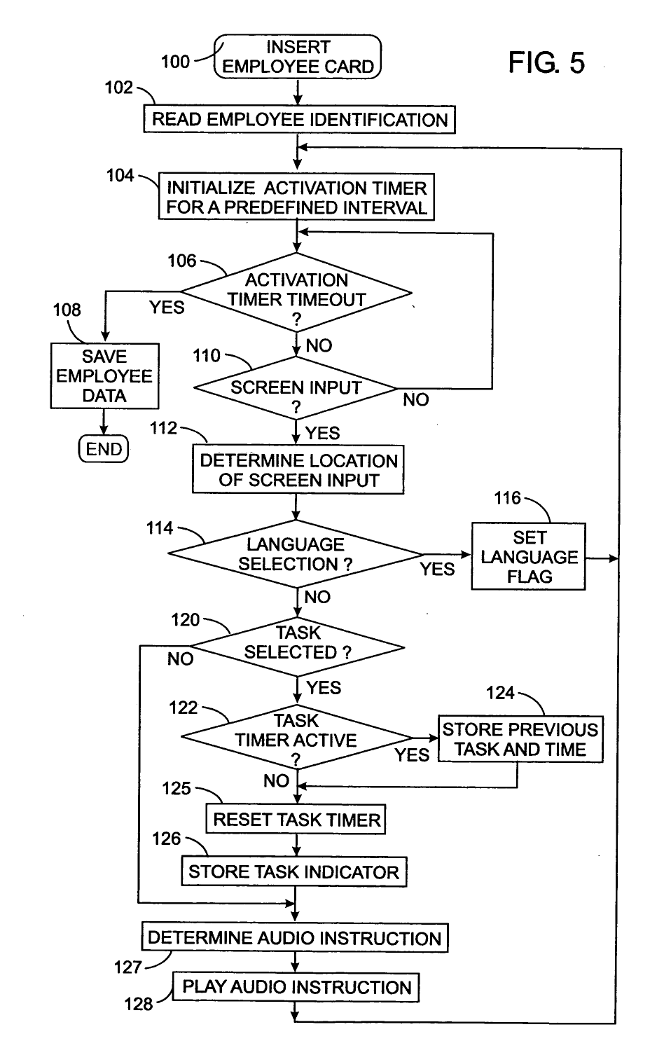

In another version of the vocational instruction apparatus 10, the card sensor 38 is a device for reading a magnetic strip or barcode on the worker's employee identification card. This identifies the particular worker and allows information about this worker's performance of the job tasks to be gathered and stored in the microcomputer's memory 53. This alternative operation is depicted in FIG. 5. The instruction is initiated at step 100 by the worker inserting his or her employee identification card into slot 20 on the front panel 14. The card sensor 38 scans the magnetic strip or barcode on that card to read an employee number or other identifier, which then is stored within the memory 53 of the microcomputer 52. The activation timer is initialized at step 104 and a determination then is made at step 106 whether the timer has elapsed. When that ultimately occurs, the program execution branches to step 108 where the data regarding the employee, that have been acquired by the instructional program, is stored within a table maintained in the microcomputer memory 53. As will described, that data includes not only the identification of the employee, but the amount of time that the worker took to perform each of the tasks at this work location.

Assuming that the activation timer has not elapsed, the inputs from the touch screen 34 are examined by the microcomputer at step 110 to determine whether the worker has activated the screen, thereby producing an input signal. If no signal is received, the procedure loops back to step 106 and continues in that loop until either the activation timer elapses or a screen input signal is found.

Upon finding an input signal from the touch screen 34, the microcomputer 52 determines the location of the screen activation at step 112. That location is processed at step 114 to ascertain whether the worker has selected one of the flag symbols 29, thereby choosing the language in which the instructions are to be delivered. When a language is selected, the microcomputer 52 sets a variable to designate that language before the program execution returns to step 104.

When the screen input does not correspond to a flag symbol, the program advances to step 120 where the microcomputers establishes whether the activated screen location corresponds to one of the task symbols 21-24 or to a implement symbol 26-28. If a implement is selected, the program execution jumps to step 127. However, when a task has been selected, the program branches to step 122 where an inspection is made whether a task timer is currently active. Each time a job task is selected, a timer is started to measure the amount of time that the worker takes to perform that specific task, thus if the presently selected task is not the first one selected during this activation of the apparatus 10, the task timer will be running at step 122. If that is the case, the instructional method branches to step 124, where the present value of the task timer are stored in a temporary cache in the microcomputer's memory 53. Then, at step 125, the task timer is reset to begin measuring the amount of time that the worker takes to perform the new task. At step 126, an indication of that new task is stored in the temporary cache.

Next at step 127, the location of the touch screen activation is used to determine the corresponding audio instruction message. The digital data encoding that message then is retrieved from the memory card 44 and used to play the audio message through the speaker 46 to the worker at step 128, After playing the audio instruction message, the program execution returns to step 104 to reset the activation timer and await selection of another task or implement symbol for instruction.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A vocational instruction apparatus for educating a worker comprising:
a plurality of symbols related to at least one job task that the worker is to perform;
a user input assembly associated with the plurality of symbols, and which upon being activated by the worker to select one of the plurality of symbols, produces an electrical signal indicating a selected symbol;
a storage device containing a plurality of audio instructional messages, each one providing information associated with a different one of the plurality of symbols; and
an audio playback circuit connected to the user input assembly and the storage device, and responding to the electrical signal by presenting, to the worker, one of the plurality of audio instructional messages that is associated with the selected symbol.

2. The apparatus as recited in claim 1 wherein the user input assembly comprises a touch screen with a plurality of areas each associated with one of the plurality of symbols.

3. The apparatus as recited in claim 2 wherein the plurality of symbols is applied over the touch screen.

4. The apparatus as recited in claim 2 wherein the plurality of symbols are printed on a sheet that is removably placed against the touch screen.

5. The apparatus as recited in claim 1 wherein the user input assembly comprises a plurality of electrical switches each associated with a different one of the plurality of symbols.

6. The apparatus as recited in claim 1 wherein each of the plurality of symbols comprises a pictorial representation of a object related to a job task that the worker is to perform.

7. The apparatus as recited in claim 1 wherein each of the plurality of symbols depicts a different job task that the worker is to perform.

8. The apparatus as recited in claim 1 wherein each of the plurality of symbols depicts a different implement that is used by the worker.

9. The apparatus as recited in claim 1 wherein the plurality of audio instructional messages provide information regarding how to perform a job task, proper use of a work implement, or workplace safety.

10. The apparatus as recited in claim 1 further comprising:
a plurality of language symbols each denoting a different language;
wherein the user input assembly also is associated with the plurality of language symbols and produces a designation of a selected language upon selection of one of the plurality of language symbols by the worker; and
wherein each of the audio instructional messages is stored in different languages in the storage device, and the audio playback circuit responds to the designation by subsequently playing an audio instructional message in the selected language.

11. The apparatus as recited in claim 10 wherein each of the plurality of language symbols depicts a flag.

12. The apparatus as recited in claim 1 further comprising:
an input device which reads an employee identification card to obtain an identifier of the worker; and
a memory device connected to the input device to store the identifier.

13. The apparatus as recited in claim 12 further comprising a timer to measure an amount of time that the worker takes to complete a job task, wherein an indication of the amount of time is stored in the memory device.

14. The apparatus as recited in claim 1 further comprising a timer to measure an amount of time that the worker takes to complete a job task.

15. The apparatus as recited in claim 1 wherein the storage device is replaceable to change the audio instructional messages.

16. The apparatus as recited in claim 1 further comprising a communication interface through which information is received for loading information into the storage device.

17. A vocational instruction apparatus for educating a worker comprising:
a housing;
a chart removably attached to the housing and having a plurality of graphical task symbols thereon each of which depicting a job task that the worker is to perform;
a user input assembly mounted to the housing and producing a first electrical signal that indicates selection of one of the graphical task symbols by the worker;
a storage device mounted to the housing and containing a plurality of audio instructional messages, each one being associated with a different job task depicted by the graphical task symbols; and
an audio playback circuit mounted to the housing and connected to the user input assembly and the storage device, the audio playback circuit responding to the first electrical signal by playing one of the plurality of audio instructional messages that is associated with the graphical task symbol selected by the worker.

18. The apparatus as recited in claim 17 further comprising a fastening arrangement to secure the housing at a location where the worker performs job tasks.

19. The apparatus as recited in claim 17 wherein the user input assembly comprises a touch screen with a plurality of areas each associated with one of the plurality of task symbols and wherein the chart is placed against the touch screen.

20. The apparatus as recited in claim 17 wherein the user input assembly comprises a plurality of electrical switches each associated with a different one of the plurality of task symbols.

21. The apparatus as recited in claim 17 wherein:
the chart also has a plurality of implement symbols depicting implement that are used by the worker;
the user input assembly produces a second electrical signal that indicates selection of one of the implement symbols by the worker to designate a selected implement;
the storage device also contains a plurality of second audio instructional messages that provide information regarding use of the implements; and
the audio playback circuit responds to the second electrical signal by playing one of the plurality of second audio instructional messages that is associated with the selected implement.

22. The apparatus as recited in claim 21 wherein each of the plurality of implement symbols comprises a pictorial representation of a implement.

23. The apparatus as recited in claim 17 wherein the plurality of audio instructional messages provide information regarding how to perform a job task, proper use of a work implement, or workplace safety.

24. The apparatus as recited in claim 17 further comprising:
plurality of language symbols each denoting a different language;
wherein the user input assembly, upon activation by the worker to select one of the plurality of language symbols, produces a second electrical signal that designates a selected language; and
wherein each of the audio instructional messages is stored in different languages in the storage device, and the audio playback circuit responds to the second electrical signal by subsequently playing an audio instructional message in the selected language.

25. The apparatus as recited in claim 24 wherein each of the plurality of language symbols depicts a flag.

26. The apparatus as recited in claim 17 further comprising:
an input device which reads an employee identification card to obtain an identifier of the worker; and
a memory device connected to the input device to store the identifier.

27. The apparatus as recited in claim 26 further comprising a timer, that is responsive to activation of the user input assembly, to measure an amount of time that the worker takes to complete a job task, wherein an indication of the amount of time is stored in the memory device.

28. The apparatus as recited in claim 17 wherein the storage device is replaceable to change the audio instructional messages.

29. The apparatus as recited in claim 17 further comprising a communication interface through which information is received for loading information into the storage device.
